(19) United States
(12) Patent Application Publication
(10) Pub. No.: US 2015/0276010 A1
(43) Pub. Date: Oct. 1, 2015

(54) VIBRATION DAMPING DEVICE

(71) Applicant: TOKAI RUBBER INDUSTRIES, LTD., Komaki-shi (JP)

(72) Inventors: Satoki NAKAMURA, Komaki-shi (JP); Hironori DAITO, Kani-shi (JP); Yuuki ISHIGAKI, Ama-gun (JP)

(21) Appl. No.: 14/335,332

(22) Filed: Jul. 18, 2014

Related U.S. Application Data
(63) Continuation of application No. PCT/JP2014/058898, filed on Mar. 27, 2014.

(51) Int. Cl. F16F 15/08; F16M 13/02

(52) U.S. Cl. CPC F16F 15/08; F16M 13/02

(57) ABSTRACT

A vibration damping device including first and second mounting members elastically connected to each other by a main rubber elastic body, and a bracket member mounted to the second mounting member and providing a stopper for restricting displacement of the first mounting member relative to the second mounting member by means of abutment between the first mounting member and the bracket member. The second mounting member includes an input portion that faces the first mounting member at a given distance. The bracket member includes an abutting portion that faces the first mounting member with the input portion being interposed therebetween. An abutting rubber layer is provided on a surface of the input portion overlapped on the abutting portion. The stopper is constituted, by abutment between the first mounting member and the abutting portion via the input portion.

### INCORPORATED BY REFERENCE

This is a Continuation of International Application No. PCT/JP2014/058898 filed on Mar. 27, 2014, the disclosure of which including the specification, drawings and abstract is incorporated herein by reference in its entirety.

### BACKGROUND OF THE INVENTION

1 Field of the Invention

The present invention relates to a vibration damping device to be used, for example, for engine mounts and the like on motor vehicles.

2. Description of the Related Art

Conventionally, there has been known a vibration damping device as a kind of vibration damping coupling body or a vibration damping supporting body interposed between the members constituting a vibration transmission system to couple or support the members each other in a vibration damping manner. The vibration damping device, as disclosed in U.S. Publication No. US 2006/0043656 for example, has a structure where a first moon ting member and a second mounting member are elastically connected by a main rubber elastic body, while a bracket member is mounted to the second mounting member.

Meanwhile, the vibration damping device of US 2006/0043656 is composed of a first stopper means that restricts relative lateral displacement of the first mounting member against the second mounting member by abutment between the first mounting member and the bracket member.

However, according to US 2006/0043656, the first mounting member is abutted against the bracket member within a specific, limited area, which imposes a risk, that the stress brought by the stopper load acts on the limited area of the bracket member in a concentrated manner so that an increase in weight of the bracket member for the purpose of securing the durability can become a problem. Also, if the mounting position of the bracket member to the vehicle is away from the input position of the stopper load, the moment of force acting on the mounted position sometimes becomes larger to make it more difficult to secure the durability of the portion of the bracket member mounted to the vehicle.

### SUMMARY OF THE INVENTION

The present invention is made against the background described above, and the problem to be solved is to provide a vibration damping device having a novel structure where the substantial position and area of the stopper load input against the bracket member can be set with a greater degree of freedom.

Aspects of the present invention designed to solve the problem above will be described below. The components adopted in each of the aspects described below are also adaptable in as many combinations as possible.

That is, a first aspect of the present invention provides a vibration damping device including: a first mounting member; a second mounting member; a main robber elastic body elastically connecting the first and second mounting members to each other; and a bracket member mounted to the second mounting member and providing a stopper for restricting an amount of displacement of the first mounting member relative to the second mounting member by means of abutment between the first mounting member and the bracket member, wherein the second mounting member includes at least one input portion that feces the first mounting member at a given, distance, the bracket member includes an abutting portion that feces the first mounting member with the input portion being interposed therebetween, an abutting rubber layer is provided on a surface of the input portion overlapped on the abutting portion, and the stopper is constituted by abutment between the first mounting member and the abutting portion via the input portion.

In the vibration damping device having the structure according to the first aspect described above, the input portion of the second mounting member overlapped on the abutting portion through the abutting rubber layer is interposed between the first mounting member and the abutting portion of the bracket member. This helps to avoid the problem with a direct input from the first mounting member to the bracket member, thus significantly improving the degree of freedom in setting the position and the working range of the stopper load against the bracket member.

A second aspect of the present invention provides the vibration, damping device according to the first aspect, wherein the input portion is integrally formed with the second mounting member.

According to the second aspect a simple structure with a fewer number of parts can be made by means of integrally forming the input portion with the second mounting member. Also, by adhering the second mounting member to the main rubber elastic body, the input portion can easily be arranged at a given position relative to the first mounting member.

A third aspect of the present invention provides the vibration damping device according to the first or second aspect, wherein the abutting rubber layer is integrally formed with the main rubber elastic body, and the abutting rubber layer and the main rubber elastic body are formed as an integrally vulcanization molded component including the first mounting member and the second mounting member having the input portion.

According to the third aspect, the structure of the device is simplified by means of integrally forming the abutting rubber layer and the main rubber elastic body while enabling to perform vulcanization molding simultaneously, which makes for easier manufacturing. In addition, an input portion provided with the abutting rubber layer can easily be placed at a given position as an integrally vulcanization molded component of the main rubber elastic body.

A fourth aspect of the present invention provides the vibration damping device according to any one of the first to third aspects, wherein an overlapping area of the abutting portion against the input portion is made larger than an abutting area of the first mounting member against the input portion in the stopper.

According to the fourth aspect, the input portion of the second mounting member and the abutting portion of the bracket member are overlapped on top of each other through the abutting rubber layer over a larger area than the abutting area of the first mounting member and the input portion. Therefore, the stopper load transmitted from the input portion to the bracket member is applied dispersedly over a wide area on the bracket, member to prevent concentrated stress from acting on the bracket member. As a result, durability of the bracket member is fully secured even if the bracket member is made thinner or formed of a material having lower specific gravity.

A fifth aspect of the present invention provides the vibration damping device according to any one of the first to fourth aspects, wherein a rubber buffer is provided on a surface of the input portion facing the first mounting member.

According to the fifth aspect, the impact force generated when the first mounting member is abutted against the input portion is reduced by the rubber buffer to prevent any hitting noise or vibration. In addition, by having the rubber buffer interposed between, the first mounting member and the input portion, the working range of the stopper load is made wider to disperse the concentration of stress.

A sixth aspect of the present invention provides the vibration damping device according to any one of the first to fifth aspects, wherein the input portion extends from the second mounting member to a side of the first mounting member, while a distal end supporting portion is provided on the bracket member to cover a distal end side of the input portion in a direction of extension.

According to the sixth aspect, the distal end supporting portion of the bracket member covers the distal end side of the input portion in the direction of extension, so that even if the stopper load caused by the abutment of the first mounting member is exerted on the input portion in a direction slanted toward the distal end side of the input portion in the direction of extension, the stopper load can. be received by the distal end supporting portion of the bracket member so that felling of the input portion off the bracket member and the like would hardly be a problem.

A seventh aspect of the present invention provides the vibration damping device according to any one of the first to sixth aspects, wherein the second mounting member has a connecting portion to be adhered to an outer peripheral surface of the main rubber elastic body, and the at least one input portion of the second mounting member comprises a pair of input portions that are arranged on opposite sides of the first mounting member while being connected to each other by the connecting portion.

According to the seventh aspect, the amount of relative displacement of the first mounting member against the second mounting member to either side thereof can be restricted by the abutment between the first mounting member and the pair of input portions. In addition, since the pair of input portions are connected to each other by the connecting portion, the pair of input portions and the connecting portion can be treated as one component making the handling easier during manufacturing.

An eighth aspect of the present invention provides the vibration damping device according to any one of the first to seventh aspects, wherein the input portion is formed of resin.

According to the eighth aspect, the input portion is made lighter than those made of metal, which achieves weight reduction of the vibration damping-device. In addition, the degree of freedom in designing the shape of the input portion is enhanced.

A ninth aspect of the present invention provides the vibration damping device according to any one of the first to eighth aspects, wherein the bracket member has a gate-shaped portion extending to stride over the first mounting member, and the abutting portion is composed of at least a part of the gate-shaped portion.

According to the ninth aspect, the stopper action that restricts the relative displacement between the first and second mounting members can be effectively obtained in more directions by the abutment between the first mounting member and the gate-shaped portion extending to stride thereover.

A tenth aspect of the present invention provides the vibration damping device according to any one of the first to ninth aspects, wherein the bracket member is of a divided structure where a first division and a second division are combined, and the second mounting member is clasped between the first and second, divisions.

According to the tenth aspect, since the bracket member is made into a structure where the first and second divisions are combined, it is now possible to impart a high rigidity against deformation to the abutting portion, for example by making the first division constituting the stopper in metal, while reducing the weight by making the second division in resin. In addition, by means of clasping the second mounting member between the first and second divisions during the assembly thereof, the second mounting member can easily be mounted to the bracket member

An eleventh aspect of the present invention provides the vibration. damping device according to any one of the first, to tenth aspects, wherein an outer periphery of a flexible film is clasped between overlapped surfaces of a basal end side of the input portion of the second mounting member in a direction of extension and the bracket member so that a fluid chamber is formed with a non-compressible fluid sealed in between the main rubber elastic body and the flexible film.

According to the eleventh aspect, mounting of the second mounting member and the bracket member and the configuration of the fluid chamber by means of clasping the outer periphery of the flexible film can all be realized in one process, thus making it easier to manufacture the fluid-filled vibration damping device.

A twelfth aspect of the present invention provides the vibration damping device according to any one of the first to eleventh aspects, wherein the input portion extends from the second mounting member to a side of the first mounting member, while a mounting part of the bracket member to a vibration transmission system is provided on a basal end side of the input portion in a direction of extension.

According to the twelfth aspect the stopper load transmitted from the input portion is exerted dispersedly against the abutting portion of the bracket member even over to the area closer to the mounting part, even if the acting position of the stopper load on the input portion of the second mounting member is away from the mounting part of the bracket. This reduces the moment of force exerted on the mounting part by the stopper load to reduce the amount of stress acting on the mounting structure of the bracket member for the vibration transmission system, thus improving the durability of the parts.

According to the present invention, the abutting portion between the first mounting member and the bracket member is indirectly abutted against each other through the input portion overlapped on the abutting portion through the abutting rubber. Therefore, the degree of freedom in setting the position and the working range of the stopper load on the bracket member is significantly improved as compared to the situation where the stopper load is directly inputted into the bracket member from the first mounting member, thus achieving reduction in the maximum stress and the like.

### BRIEF DESCRIPTION OF THE DRAWINGS

The foregoing and/or other objects, features and advantages of the invention will become more apparent from the following description of a preferred embodiment with reference to the accompanying drawings in which like reference numerals designate like elements and wherein:

FIG. 1 is a perspective view stowing a vibration damping device in the form of an engine mount as a first embodiment of the present invention with a first bracket mounted thereto;

FIG. 2 is a longitudinal cross sectional view of the engine mount with the bracket shown in FIG. 1;

FIG. 3 is a perspective view of a second mounting member of the engine mount shown in FIG. 2; and

FIG. 4 is an exploded perspective view of the engine mount shown in FIG. 2.

### DETAILED DESCRIPTION OF PREFERRED EMBODIMENTS

Embodiments of the present invention will be described below in reference to the drawings.

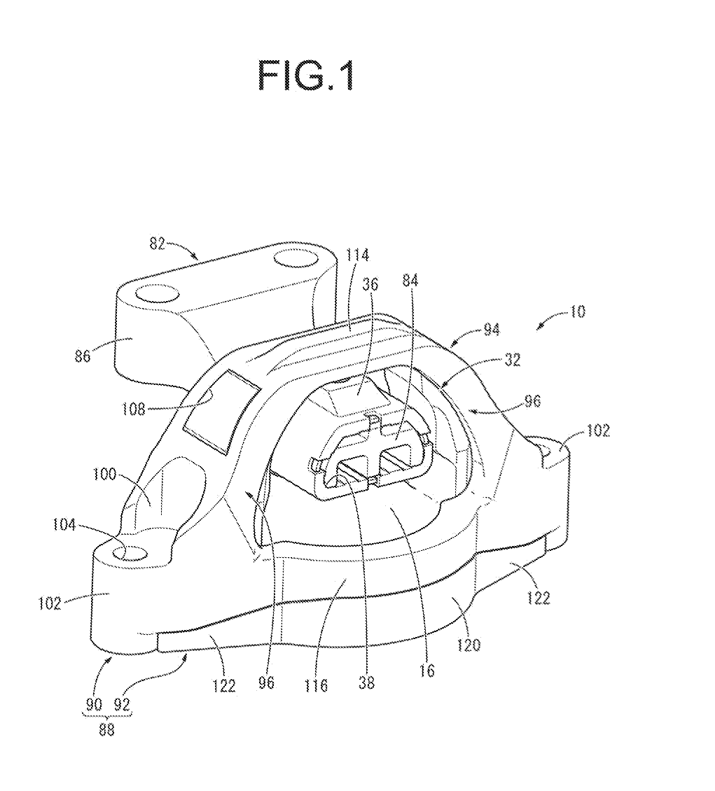

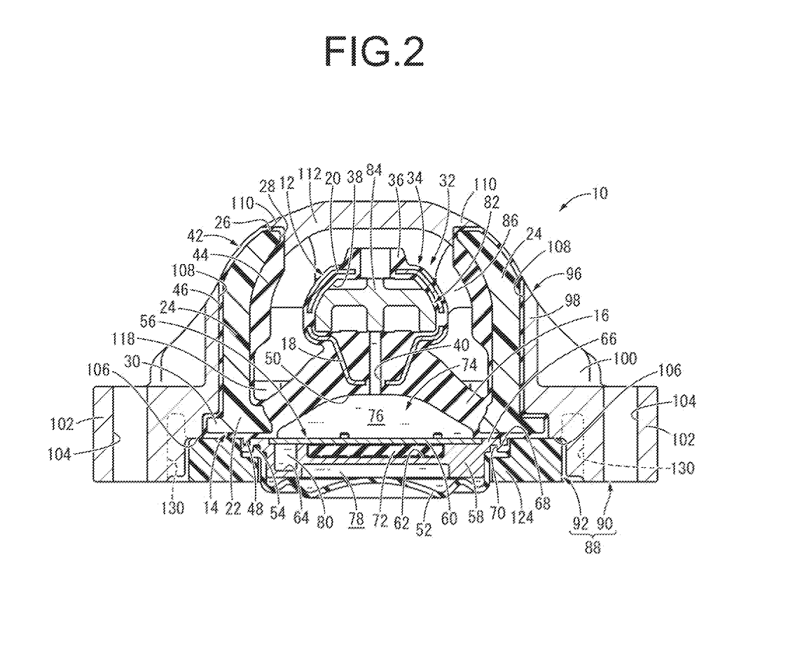

FIGS. 1 and 2 show an engine mount 10 for motor vehicles as a first, embodiment of the vibration damping device having the structure according to the present invention. The engine mount 10 has a structure where a first mounting member 12 and a second mounting member 14 are elastically connected to each other by a main rubber elastic body 16. In the following description, as a general rule the up-down direction means an up-down direction of the engine mount in a state of being mounted to a vehicle represented by the up-down direction in FIG. 2, the front-rear direction means a front-rear direction of the vehicle represented by the left-right direction in FIG. 2, and the left-right direction means a left-right direction of the vehicle represented by the direction perpendicular to the plane of the page of FIG. 2.

More specifically, the first mounting member 12 is a high-rigidity member formed of metal such as iron or aluminum alloy and is integrally provided with an adhering portion 18 in an approximate shape of a reverse circular truncated cone in a hollow form and a cylindrical joint fitting 20 extending in the left-right direction.

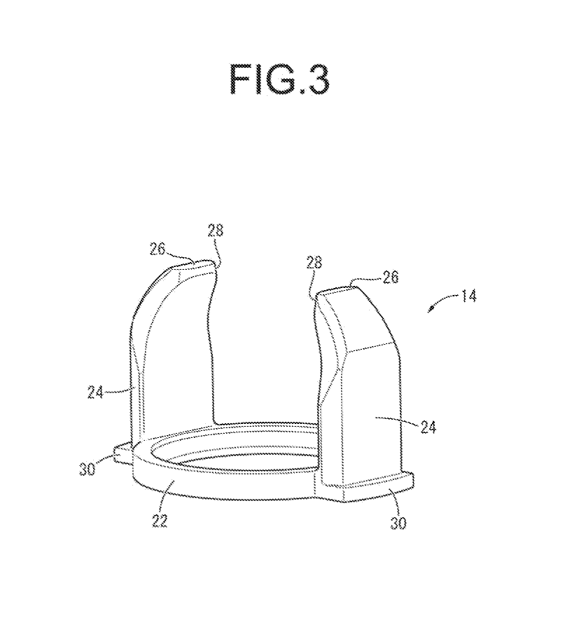

The second mounting member 14 is a hard member formed of synthetic resin and, as shown in FIGS. 2 and 3, is integrally provided with a connecting portion 22 approximately in a thick annular shape with a large-diameter and a pair of input portions 24, 24 extending upward from the connecting portion 22. The input portions 24 have a plate shape with a given width in the circumferential direction of the connecting portion 22, and are formed in a pair facing each other in. one radial direction of the connecting portion 22 while being connected to each other by the connecting portion 22. Further, the input portion 24 is in an approximate shape of a fiat plate with the lower portion extending linearly in the up-down direction, while the upper portion curves inward on the left and right sides as it goes up. Moreover, the edge surface of the extended input portion 24 is provided with an upper supported face 26 that extends nearly perpendicular to the up-down direction and an inner supported face 28 that extends nearly perpendicular to the front-rear direction. Also, at the basal end of the input portion 24 (edge of the connecting portion 22), a clasped protrusion 30 that protrudes Outward in the direction of facing of the pair of input portions 24, 24 is integrally formed continuously ail the way across the width of the input portion 24.

And the first mounting member 12 is arranged above and away from the connecting portion 22 of the second mounting member 14, and the first mounting member 12 and the second mounting member 14 are elastically connected by the main rubber elastic body 36. The main rubber elastic body 16 is in an approximate shape of a thick, large-diameter circular truncated cone, the small-diameter end of which is adhered by vulcanization to the adhering portion 18 of the first mounting member 12, while the outer peripheral surface of the large-diameter end is adhered by vulcanization to the connecting portion 22 of the second mounting member 14. The main rubber elastic body 16 is also formed as an integrally vulcanization molded component 32 provided with the first mounting member 12 and the second mounting member 14. Also, in the integrally vulcanization molded component 32 of the main rubber elastic body 16, the pair of input portions 24, 24 of the second mounting member 14 extend to each side in front and rear of the first mounting member 12 to be arranged facing the first mounting member 12 at a given distance.

Further, a rubber fitting 34 integrally formed with the main rubber elastic body 16 is adhered to the cylindrical joint fitting 20 of the first mounting member 12. The rubber fitting 34 is a rubber layer that covers both the inner and outer surfaces of the cylindrical joint fitting 20 provided with a fitting hole 38 formed on the inner peripheral side, while a rubber stopper 36 partially made thicker is integrally formed with the upper surface of the cylindrical joint fitting 20 protruding upward. Also, a recess on the inner peripheral side of the adhering portion 18 is filled with the rubber fitting 34. On the rubber fitting 34 comprising the first mounting member 12 and the rubber stopper 36, a filler hole 40 is formed penetrating therethrough in the up-down direction. Also, a buffer plate 41 integrally formed with the rubber fitting 34 protrudes toward, one of the openings of the cylindrical joint fitting 20 in the lower portion thereof.

Moreover, a rubber coating 42 integrally formed with the main rubber elastic body 16 is adhered to the second mounting member 14. The rubber coaling 42 is formed by being deposited nearly on the entire surface of the second mounting member 14, and the portion of adhesion to the upper inner peripheral surface of the input portion 24 constitutes a rubber buffer 44 that is partially thick-walled, while the portion of adhesion to the lower outer peripheral surface of the input portion 24 constitutes an abutting rubber layer 46. In part of the rubber coating 42 that covers the bottom surface of the connecting portion 22 of the second mounting member 14, a first fitting protrusion 48 is formed all around the circumference protruding downward. Also, in the present embodiment, the main rubber elastic body 16 and the rubber coating 42 are formed as an integrally vulcanization molded component 32 including the first mounting member 12 and the second mounting member 14 having the input portion 24.

In addition, a large-diameter recess 50 is formed on the main rubber elastic body 16. The large-diameter recess 50 is a recess in an approximate shape of a reverse bowl gradually increasing its diameter toward the opening, which opens to the large-diameter side of the main rubber elastic body 16. The filler hole 40 opens on the inner surface of the top wall of the large-diameter recess 50.

Also, a flexible film 52 is attached to the second mounting member 14. The flexible film 52 is a thin circular rubber membrane having slack on the top and bottom with some allowance for deformation by expansion and contraction and so forth. Further, a second fitting protrusion 54 is integrally formed with the flexible film 52 along the outer periphery protruding upward.

Also, between the main rubber elastic body 16 and the flexible film 52, a partition member 56 is arranged. The partition member 56 is a hard member in an approximate shape of a circular plate structured to have a cover plate 60 overlapped on a partition member main body 58.

The partition member main body 58 is in an approximate shape of a thick circular plate where a housing recess 62 is formed at the center thereof in the radial direction extending in the up-down direction with a near circular cross section opening on the upper surface. Further, along the outer periphery of the partition member main body 58, a peripheral groove 64 is formed to extend in a given length less than a circuit in the circumferential direction opening on the upper surface. Moreover, a supporting flange 66 is integrally formed with the partition member main body 58 at the top end protruding toward the outer periphery, and along the outer periphery of the supporting flange 66, a main rubber fitting groove 68 is formed in an annular shape opening to the top surface thereof, while a flexible film fitting groove 70 is formed in an annular shape along the inner periphery of the supporting flange 66 opening to the bottom surface thereof.

The cover plate 60 is made in an approximate shape of a thin circular plate and is overlapped on the top surface of the partition member main body 58. Also, between the partition member main body 58 and the cover plate 60, a movable plate 72 is arranged. The movable plate 72 is a rubber elastic body in an approximate shape of a circular plate and is housed in the housing recess 62 of the partition member main body 58, while being arranged with some allowance for displacement in the up-down direction between the partition member main body 58 and the cover plate 60 by having the opening of the housing recess 62 covered with the cover plate 60.

And the second mounting member 14 is overlapped on the supporting flange 66 of the partition member main body 58 from above, while the flexible film 52 is overlapped thereon from below. The second mounting member 14 and the flexible film 52 are each positioned against the partition member 56 in the axis-perpendicular direction by means of inserting the first fitting protrusion 48 protruding from the robber coating 42 into the main rubber fitting groove 68 of the partition member main body 58 and inserting the second fitting protrusion 54 protruding from the flexible film 52 into the flexible film fitting groove 70 of the partition member main body 58.

Also, a fluid chamber 74 is formed between the main rubber elastic body 16 and the flexible film 52. which is divided into two sections up and down by the partition member 56. This forms a pressure-receiving chamber 76 to the upper side of the partition member 56 whose wall is partially defined by the main rubber elastic body 16 and which is subjected to internal pressure fluctuations during input of vibration, while forming an equilibrium chamber 78 to the lower side of the partition member 56 whose wall is partially defined by the flexible film 52 and that permits changes in volume.

In addition, a non-compressible fluid is poured into the pressure-receiving chamber 76 and the equilibrium chamber 78 via the filler bole 40 to be sealed therein. The non-compressible fluid sealed therein is not particularly limited, but for example, water, ethylene glycol, alkylene glycol, polyalkylene glycol, silicone oil, or a mixture liquid thereof and the like can be adopted. More preferably, it is desirable to use a fluid of low viscosity at 0.1 Pa·s or less in order to efficiently obtain the vibration damping effect based on the fluid flow action described later. In the present embodiment, the tiller hole 40 is to be closed fluid tight by a first bracket 82 by installing the first bracket 82, described later, to the first mounting member 12 after sealing in the non-compressible fluid. However, it is also possible to seal off the filler hole 40 before the installation of the first bracket 82 by means of pressing a plug of ball form, or the like into the portion of the filler hole 40 where the fitting hole 38 and the large-diameter recess 50 are communicated with each other.

Moreover, the opening of the peripheral groove 64 at its both ends in the circumferential direction is communicated with each one of the pressure-receiving chamber 76 and the equilibrium chamber 78 to form an orifice passage 80 that communicates the pressure-receiving chamber 76 and the equilibrium chamber 78 with each other. The tuning frequency of the orifice passage 80, which is the resonant frequency of flowing fluid, is set as low as about 10 Hz at an equivalent level to that of the engine shake by means of adjusting the ratio (A/L) of the passage section area (A) to the passage length (L) taking into account the spring rigidity of the wails of the pressure-receiving chamber 76 and the equilibrium chamber 78.

In addition, a plurality of through holes 81 are formed on the bottom wall of the housing recess 62 of the partition member main body 58 and in the portion of the cover plate 60 that covers the opening of the housing recess 62, respectively, whereas the liquid pressure of the pressure-receiving chamber 76 is exerted on the upper face of the movable plate 72 via these through holes 81, while the liquid pressure of the equilibrium chamber 78 is exerted on the bottom face of the movable plate 72. This allows the liquid pressure of the pressure-receiving chamber 76 to be transmitted to the equilibrium chamber 78 by a slight displacement of the movable plate 72 within the housing recess 62.

In the present embodiment, the first bracket 82 is mounted to the first mounting member 12. The first bracket 82, as shown in FIG, 1, has a structure integrally provided with a fitting rod 84 to be attached to the cylindrical joint fitting 20 of the first mounting member 12 and an attachment part 86 to be attached to an unillustrated power unit. Then, the first bracket 82 is fixed to the first mounting member 12 by having the fitting rod 84 of the first bracket 82 fit into the fitting hole 38 formed on the inner periphery of the cylindrical joint fitting 20. By mounting the first bracket 82 to the first mounting member 12, the filler hole 40 is shut off by the first bracket 82 so as to seal the non-compressible fluid in the pressure-receiving chamber 76 and the equilibrium chamber 78.

Also, a second bracket 88 as a bracket, member is mounted to the second mounting member 14. The second bracket 88 is of a divided structure where a bracket, main body 90 as a first division and a base member 92 as a second division are combined.

The bracket main body 90 is a high-rigidity member formed of metal such as iron, aluminum alloy or fiber-reinforced synthetic resin, and has a gate-shaped portion 94 extending In the front-rear direction striding over the upper portion of the first mounting member 12. The gate-shaped portion 94 extends in the up-down direction and is provided with a pair of legs 96, 96 facing each other in the front-rear direction.

The leg 96 has a lower portion extending linearly in the up-down direction, and the center thereof in the left-right direction constitutes an abutting portion 98, while a reinforcing rib 100 is integrally formed to protrude outward on the front and rear sides of the left and right ends so as to enhance the deformation, rigidity of the leg 96. In addition, at the bottom end of the leg 96, a mounting part 102 is provided to protrude outward on the front and rear sides thereof. The mounting part 102, provided with a bolt hole 104 penetrating therethrough, is to be mounted to a vehicular body (not illustrated), which is a vibration transmission system, by a bolt inserted into the bolt hole 104. The mounting part 102 is provided with an abutting step face 106 on the inner surface on the front and rear sides.

Further, the upper portion of the leg 96 is made in a curved form tilting inward on the front and rear sides as it goes up, while a window portion 108 is formed to penetrate therethrough in the up-down direction with an approximately square section. The leg 96 is integrally formed with a distal end supporting portion 110 protruding outward from the upper edge of the window portion 108 on the front and rear sides.

Also, the pair of legs 96, 96 are arranged to face each, other in the front-rear direction, upper ends of which, are connected to each other by a beam 112. The beam 112 is made in a plate form extending in the front-rear direction nearly perpendicular to the up-down direction, the front and rear ends of which are integrally connected to either of the pair of legs 96, 96. In addition, in the middle portion of the beam 112 in the left-right direction, a reinforcing rib 114 is formed to protrude upward, thus enhancing the deformation, rigidity of the beam 312.

Also, in the gate-shaped portion 94 provided with the pair of legs 96, 96 and the beam 112, a pair of reinforcing joints 116, 116 are provided. The reinforcing joint 116 extends in the circumferential direction in a curved form bulging toward outside on the left and right sides, and the bottom portions of the pair of legs 96, 96 are connecter to each other by the pair of reinforcing joints 116, 116. In addition, along the top edge of the reinforcing joint 116, a pressing protrusion 118 is formed continuously almost all along the length,

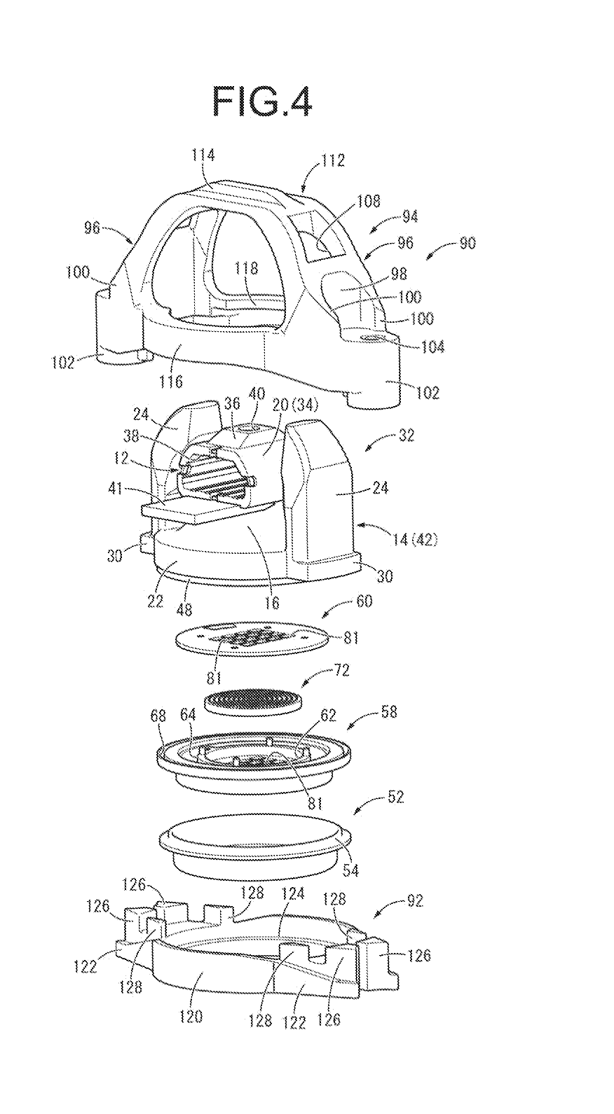

The bracket main body 90 having the structure described above is attached with the base member 92. The base member 92, as shown in FIG. 4, is integrally provided with a main body 120 in an annular shape and a pair of joint fittings 122, 122 in the front and rear. The main body 120 is provided continuously all the way around the circumference, and a compression step 124 is integrally formed at the bottom end protruding toward inner periphery. The joint fitting 122 is in an approximate shape of a plate protruding outward from the main body 120 on the front and rear sides, and a pair of fitting protrusions 126, 126 are integrally formed therewith to protrude upward on the outside in the front and rear while on the inside in the front and rear, a pair of locking protrusions 128, 128 are integrally formed apart from each other at a given distance in the circumferential direction.

And the bracket main body 90 is overlapped with the base member 92 from above, whereas the fitting protrusion 126 is fitted into a fitting recess 130 formed on the mounting part 102 of the bracket main body 90. Then, the bracket main body 90 and the base member 92 are fixed to each other by bonding or adhesion to form the second bracket 88. The bracket main body 90 and the base member 92 are positioned against each other by having the upper face of the base member 92 abutted against the abutting step lace 106 of the bracket main body 90.

Also, the integrally vulcanization molded component 32, the flexible film 52, and the partition member 56 are assembled in between the bracket main body 90 and the base member 92. In other words, the clasped protrusion 30 of the second mounting member 14 is inserted into the space between the pair of mounting parts 102, 102 by having the bracket main body 90 externally inserted from above into the integrally vulcanization molded component 32 to be overlapped on the bottom face of the leg 96. In addition, the input portion 24 of the second mounting member 14 covered with the rubber coating 42 has its lower portion overlapped with the abutting portion 98 of the gate-shaped portion 94 in the front-rear direction and its upper portion inserted into the window portion 108 of the gate-shaped portion 94. This allows the integrally vulcanization molded component 32 of the main rubber elastic body 16 to be mounted to the bracket main body 90.

In the present embodiment, the extended end faces (upper supported face 26 and inner supported face 28) of the input portion 24 covered by the rubber coating 42 are overlapped with and abutted against the top inner face of the window portion 108. Also, the extended basal end of the input portion 24 covered with the rubber coating 42 is inserted between the pair of locking protrusions 128, 128, and the integrally vulcanization molded, component 32 provided with the input portion 24 is positioned relative to the second bracket 88 in the circumferential direction. Also, the mounting part 102 of the bracket main body 90 is arranged on the extended basal end side of the input portion 24.

Further, the partition member 56 is temporarily assembled to the integrally vulcanization molded component 32 of the main rubber elastic body 16 by inserting the first fitting protrusion 48 protruding at the bottom of the second mounting member 14 into the main rubber fitting groove 68. Moreover, the flexible film 52 is temporarily assembled to the partition member 56 by inserting the second fitting protrusion 54 of the flexible film 52 into the flexible film fitting groove 70.

And the clasped protrusion 30 of the second mounting member 14 is clasped in the up-down direction between the bottom face of the leg 96 of the bracket main body 90 and the joint fitting 122 of the base member 92 by means of fixing the base member 92 to the bracket main body 90. In addition, the connecting portion 22 of the second mounting member 14 is clasped in the up-down direction between the pressing protrusion 118 at the reinforcing joint 116 of the bracket main, body 90 and the main, body 120 of the base member 92. These allow the second mounting member 14 to be fixed to the second bracket 88. In summary, in the present, embodiment, the second bracket 88 constitutes a divided structure where the second mounting member 14 is easily installable by means of clasping the second mounting member 14 between the bracket main body 90 and the base member 92.

Further, the partition member 56 and the flexible film 52 are fixed to the second mounting member 14 and the second bracket 88 by having the supporting flange 66 of the partition member 56 and the outer peripheral edge of the flexible film 52 clasped between the second mounting member 14 and the compression step 124 of the base member 92 in the up-down direction. Moreover, the overlapping face between the second mounting member 14 and the partition member 56 and the overlapping face between the partition member 56 and the flexible film 52 are both sealed fluid fight by having the rubber coating 42 adhered to the second mounting member 14 as well as the outer peripheral edge of the flexible film 52 abutted against the upper and lower faces of the partition member 56, respectively. Thus, the fluid chamber 74 sealed fluid tight is formed between the main rubber elastic body 16 and the flexible film 52 by the installation of the second bracket 88 so that the overlapping feces of the second mounting member 14 and the flexible film 52 against the partition member 56 are easily sealed.

Also, the abutting rubber layer 46 is arranged in the overlapping interface between the outer faces of the front and rear of the input portion 24 of the second mounting member 14 and the inner feces of the front and rear of the abutting portion 98 of the second bracket 88, whereby the input portion 24 and the abutting portion 98 are overlapped with and abutted against each other via the abutting rubber layer 46. Further, the upper supported face 26, which is the extended end face of the input portion 24, is overlapped with and abutted against the distal end supporting portion 110 of the second bracket 88 through the rubber coating 42, while the inner supported face 28 is overlapped with and abutted against the upper inner peripheral surface of the window portion 108 through the rubber coating 42. Since the second mounting member 14 covered with the rubber coating 42 is abutted against the second bracket 88 in the present embodiment, a slight relative displacement of the second mounting member 14 against the second bracket 88 is allowed by elastic deformation of the rubber coating 42. Moreover, the overlapping area between the input portion 24 and the abutting portion 98 is made larger than the abutting area between the first mounting member 12 and the input portion 24 in the stopper described later.

Also, the pair of input portions 24, 24 of the second mounting member 14 are arranged facing the first mounting member 12 at a given distance to each side (outward in the front and rear), respectively, while the pair of abutting portions 98, 98 of the second bracket 88 are facing the first mounting member 12 with the respective input portions 24 being interposed therebetween. The first mounting member 12 is arranged facing the adhering portion of the rubber buffer 44 of the input portion 24 and faces the inner face in front and rear of the rubber buffer 44 at a given distance.

The engine mount 10 with the structure described above has the first mounting member 12 mounted to an unillustrated power unit via the first bracket 82 and the second mounting member 14 installed in a vehicle by being mounted to an unillustrated vehicular body.

Then, in a state of being mounted on a vehicle, once a low-frequency large-amplitude vibration equivalent to that of the engine shake is inputted between the first mounting member 12 and the second mounting member 14 in the up-down direction, relative pressure fluctuations are caused between the pressure-receiving chamber 76 and the equilibrium chamber 78. Then fluid flow is generated through the orifice passage 80 between the pressure-receiving chamber 76 and the equilibrium chamber 78, thus exerting the vibration damping effect (high attenuation effect) based on the fluid flow action.

Also, in a state of being mounted on a vehicle, once a medium to high-frequency small-amplitude vibration equivalent to the idling vibration or muffled sounds of a running vehicle is inputted between the first mounting member 12 and the second mounting member 14 in the up-down direction, the orifice passage 80 gets substantially closed due to the anti-resonance action. Meanwhile, because of the relative pressure difference between the pressure-receiving chamber 76 and the equilibrium chamber 78, the movable plate 72 is slightly displaced in the up-down direction within the housing recess 62. This allows the liquid pressure in the pressure-receiving chamber 76 to be transmitted to the equilibrium chamber 78 to be absorbed by deformation of the flexible film 52 so that a significant rise in the dynamic spring constant due to the tight sealing of the pressure-receiving chamber 76 can be avoided, thus exerting the intended vibration damping effect (low dynamic spring effect).

Also, once a large load is inputted in the front-rear direction between the first mounting member 12 and the second mounting member 14, a stopper is configured that restricts the relative displacement between the first mounting member 12 and the second mounting member 14 in the front-rear direction by having the first mounting member 12 and the abutting portion 98 of the second bracket 88 abutted against each other.

Further, the abutting portion 98 of the second bracket 88 faces the first mounting member 12 with the input portion 24 of the second mounting member 14 being interposed therebetween so that the first mounting member 12 is abutted against the abutting portion 98 via the input portion 24 in the stopper. Under these circumstances, the input portion 24 of the second mounting member 14 is overlapped with and abutted against the abutting portion 98 of the second bracket 88 through the abutting rubber layer 46. This allows the load exerted on the input portion 24 by the abutment of the first mounting member 12 to be transmitted dispersedly to the abutting portion 98 of the second bracket 88 over a wide area. Therefore, concentration of stress at the second bracket 88 is prevented, thus enabling to obtain enough load-bearing capacity while reducing the weight of the second bracket 88 by thinning the walls thereof. Especially in the present embodiment, since the overlapping area between the input portion 24 and the abutting portion 98 is made larger than that between the first mounting member 12 and the input portion 24 in the stopper, dispersion of the stopper toad can he achieved more effectively.

In addition, since the first mounting member 12 and the second mounting member 14 are made to abut against each other through the rubber buffer 44 adhered to the input portion 24 in the present embodiment, the hitting noise caused by the impact of abutment is reduced and the stress is applied dispersedly over a wide area of the input portion 24.

Further, since the overlapping face between the input portion 24 and the abutting portion 98 extends downward from the abutting position of the first mounting member 12 against the input portion 24, the positions of input of the stopper load against the abutting portion 98 are dispersed to the proximity of the mounting part 102, This allows the moment of force of the stopper load applied to the mounting pan 102 to be reduced, thus preventing any damage to the portion where the second bracket 88 is mounted on a vehicular body.

Also, in the present embodiment, since the gate-shaped portion 94 straddling over the first mounting member 12 in its upper portion is provided in the bracket main body 90 and the pair of legs 96, 96 provided with the abutting portion 98, each being abutted against the input portion 24, are connected to each other by the beam 112 at the upper end, it is now possible to set more superb load-bearing capacity for the abutting portion 98.

Further, the beam 112 of the gate-shaped portion 94 is arranged above and facing the first mounting member 12 at a given distance, and a rebound stopper is configured that restricts the relative displacement of the first mounting member 12 against the second bracket 88 by the abutment of the beam 112 against the first mounting member 12 in the up-down direction. In the present embodiment, since the first mounting member 12 abuts against the beam 112 through the rubber stopper 36, the hitting noise and impact can be reduced.

In the present embodiment, the bound stopper is configured to restrict the relative displacement of the first mounting member 12 downward against the second mounting member 14 (second bracket 88) by means of having the first bracket 82 abutted against the reinforcing joint 116 of the second bracket 88 in the up-down direction through the buffer plate 41. Therefore, in the engine mount 10 of the present embodiment, the stopper action can be exerted on the upper and lower sides as well as on the front and rear sides of the vehicle, thus improving the durability of the device against large-load inputs in multiple directions.

Also, the second bracket 88 of the present embodiment is formed by assembling the bracket main body 90 and the base member 92 that are made separate from each other. This allows the bracket main body 90 provided with the gate-shaped portion 94 constituting the stopper to be formed of metal such as aluminum alloy to set a higher deformation rigidity, whereas, if the base member 92 that is unlikely to be charged with a large load is formed of a tight and inexpensive material such as synthetic resin, reductions in weight and cost of the engine mount 10 can be achieved.

An embodiment of the present invention has been described above, but the specific descriptions of the embodiment do not limit the present invention. For example on the previous embodiment, a structure where each, pair of the input portions 24 of the second mounting member 14 and the abutting portions 98 of the second bracket 88 is exemplified, but only one of either can be provided.

Also, the specific shape of the input portion is not particularly limited, but it can be made linear ail the way to the top end without curving.

Further, in the previous embodiment, the input portion 24 is integrally provided with, the second mounting member 14, but the input portion can be made separate from the second mounting member. By means of providing the input portion separate from the second mounting member, the stopper load is prevented from directly acting on the second mounting member so as to restrict the deformation thereof thus preventing deterioration of the sealing performance of the fluid chamber.

Also, the rubber buffer can be formed to protrude from the outer peripheral surface of the first mounting member 12. In that case, the rubber buffer 44 is not necessarily needed for the input portion 24.

Also, the distal end supporting portion covering the extended distal end of the input portion can be provided at the extended distal end side of the abutting portion, for example.

Also, the bracket member does not necessarily need the beam 112, and the gate-shaped portion 94 does not necessarily have to be provided. Therefore, the rebound stopper means using the beam 112 is not essential.

Also, the bracket member is not necessarily limited to the divided structure combining a plurality of divisions, but it can be a single member integrally formed as a whole.

The present invention is not only applied to fluid-filled vibration damping devices but can also be applied to vibration damping devices with, no fluid sealed therein, and also can be applied to active fluid-filled vibration damping devices that actively control the liquid pressure in the fluid chamber by an actuator, or even to fluid-tilled switching vibration damping devices that switch on and off the communication of a plurality of orifice passages with various tuning frequencies.

The prevent invention is not limited to the vibration, damping device used as an engine mount but also applicable to the vibration damping device used for sub-frame mounts, body mounts, differential mounts and so forth. Also, the application scope of the present invention, is not limited to the vibration damping device for motor vehicles but is also applicable to the vibration damping device far motorcycles, rail road vehicles, industrial vehicles and the like.

What is claimed is:

1. A vibration damping device comprising:
a first mounting member;
a second mounting member;
a main rubber elastic body elastically connecting the first and second mounting members to each other; and
a bracket member mounted to the second mounting member and providing a stopper for restricting an amount of displacement of the first mounting member relative to the second mounting member by means of abutment between the first mounting member and the bracket member, wherein
the second mounting member includes at least one input portion that faces the first mounting member at a given distance,
the bracket member includes an abutting portion that faces the first mounting member with the input portion being interposed therebetween,
an abutting rubber layer is provided on a surface of the input portion overlapped on the abutting portion, and
the stopper is constituted by abutment between the first mounting member and the abutting portion via the input portion,

2. The vibration damping device according to claim 1, wherein the input portion is integrally formed with the second mounting member.

3. The vibration damping device according to claim 1, wherein the abutting rubber layer is integrally formed with the main rubber elastic body, and the abutting rubber layer and the main rubber elastic body are formed, as an integrally vulcanization molded component including the first mounting member and the second mounting member having the input portion,

4. The vibration damping device according to claim 1, wherein an overlapping area of the abutting portion against the input portion is made larger than an abutting area of the first mounting member against the input portion in the stopper.

5. The vibration damping device according to claim 1, wherein a rubber buffer is provided on a surface of the input portion facing the first mounting member.

6. The vibration damping device according to claim 1, wherein the input portion extends from the second mounting member to a side of the first mounting member, while a distal end. supporting portion is provided on the bracket member to cover a distal end side of the input portion in a direction of extension.

7. The vibration damping device according to claim 1, wherein the second mounting member has a connecting portion to he adhered to an outer peripheral surface of the main robber elastic body, and the at least one input portion of the second mounting member comprises a pair of input portions that are arranged on opposite sides of the first mounting member while being connected to each other by the connecting portion.

8. The vibration damping device according to claim 1, wherein the input portion is formed of resin.

9. The vibration damping device according to claim 1, wherein the bracket member has a gate-shaped portion extending to stride over the first mounting member, and the abutting portion is composed of at least a part of the gate-shaped portion.

10. The vibration damping device according to claim 1, wherein the bracket member is of a divided structure where a first division and a second division are combined, and the second mounting member is clasped between the first and second divisions.

11. The vibration damping device according to claim 1, wherein an outer periphery of a flexible film is clasped between overlapped surfaces of a basal end side of the input portion of the second mounting member in a direction of extension and the bracket member so that a fluid chamber is formed with a non-compressible fluid sealed in between the main rubber elastic body and the flexible film.

12. The vibration damping device according to claim 1, wherein the input portion extends from the second mounting member to a side of the first mounting member, while a mounting part of the bracket member to a vibration transmission system is provided on a basal end side of the input portion in a direction of extension.
